(19) United States
(12) Patent Application Publication
(10) Pub. No.: US 2015/0324918 A1
(43) Pub. Date: Nov. 12, 2015

(54) METHODS AND SYSTEMS FOR COLLABORATIVE PORTFOLIO OPTIMIZATION

(71) Applicant: SELFWEALTH LTD, SUREY HILLS, VIC (AU)

(72) Inventor: Andrew WARD, Hawthorn East Victoria (AU)

(21) Appl. No.: 14/651,958

(22) PCT Filed: Dec. 12, 2013
(86) PCT No.: PCT/IB2013/002743

§ 371 Date: Jun. 12, 2015

Related U.S. Application Data
(60) Provisional application No. 61/809,987, filed on Apr. 9, 2013.

(30) Foreign Application Priority Data
Dec. 12, 2012 (AU) 2012905425

(51) Int. Cl. G06Q 40/06

(52) U.S. Cl. CPC G06Q 40/06

(57) ABSTRACT

Method and systems for collaborative portfolio optimisation comprising aggregating, in a server, data associated with portfolios of investments of an online community of users; determining, using the server, performance and risk of each portfolio; and generating, using the server, user interfaces presented on clients that enable users to: filter, compare and follow portfolios of other users based on portfolio performance and risk; add portfolios being followed into target portfolios; and select percentage weightings of portfolios being followed that are added into the target portfolios.

### FIELD

The present invention relates to methods and systems for collaborative portfolio optimisation.

### BACKGROUND

Selecting an optimal portfolio of investments is a challenging analytical task in which individuals must choose among many different investments with varying risk and return attributes.

While portfolio selection is an important yet difficult problem, current personal financial management platforms do not allow individual private investors to easily create, compare and select among investment portfolios of professional and other private investors to optimise the composition and performance of their own portfolios.

### SUMMARY

According to the present invention, there is provided a method, comprising:

aggregating, in a server, data associated with portfolios of investments of an online community of users;

determining, using the server, performance and risk of each portfolio; and

generating, using the server, user interfaces presented on clients that enable users to:
filter, compare and follow portfolios of other users based on portfolio performance and risk;
add portfolios being followed into target portfolios; and
select percentage weightings of portfolios being followed that are added into the target portfolios.

The user interfaces may further enable users to identify trades of investments required to rebalance actual portfolios into target portfolios.

The method may further comprise:

determining, using the server, top N performing portfolios of investments out of actual and target portfolios of the online community of users;

determining, using the server, top N performing investments out of the top N performing portfolios of investments; and

weighting, using the server, the top N performing investments to create a collaborative index of investments for the online community of users;

wherein N is a multiple of 5.

The method may further comprise electronically publishing, using the server, the collaborative index.

The method may further comprise creating, using the server, a collaborative exchange-traded fund comprising the top N performing investments.

The user interfaces may further enable users to filter, compare and follow portfolios of other users based on user profiles or user risk tolerances.

The user interfaces may further enable individual users to compare performance of individual actual or target portfolios with the collaborative index and/or a market index.

The online community of users may be selected from one or more online sub-communities comprising professional investors, members of online social networks, subscribers to online financial services, members of self managed superannuation funds (SMSFs), and combinations thereof.

The present invention also provides a system, comprising:

an aggregation module configured to aggregate, in a server, data associated with portfolios of investments of an online community of users;

an analysis module configured to determine, using the server, performance and risk of each portfolio; and

an interface module configured to generate, using the server, user interfaces presented on clients that enable users to:
filter, compare and follow portfolios of other users based on portfolio performance and risk;
add portfolios being followed into target portfolios; and
select percentage weightings of portfolios being followed that are added into the target portfolios.

The system may further comprise a rebalancing module configured to generate, using the server, user interfaces presented on clients that enable users to identify trades of investments required to rebalance actual portfolios into target portfolios.

The system may further comprise an indexing module configured to:

determine, using the server, top N performing portfolios of investments out of actual and target portfolios of the online community of users;

determine, using the server, top N performing investments out of the top N performing portfolios of investments; and

weight, using the server, the top N performing investments to create a collaborative index of investments for the online community of users;

wherein N is a multiple of 5.

### BRIEF DESCRIPTION OF DRAWINGS

Embodiments of the invention will now be described by way of example only with reference to the accompanying drawings, in which:

FIG. 1 is a block diagram of an example system for collaborative portfolio optimisation according to an embodiment of the invention;

FIG. 2 is a flowchart of an example method implemented by the system; and

FIGS. 3 to 14 are example screenshots of user interfaces presented by the system during implementation of the method.

### DETAILED DESCRIPTION

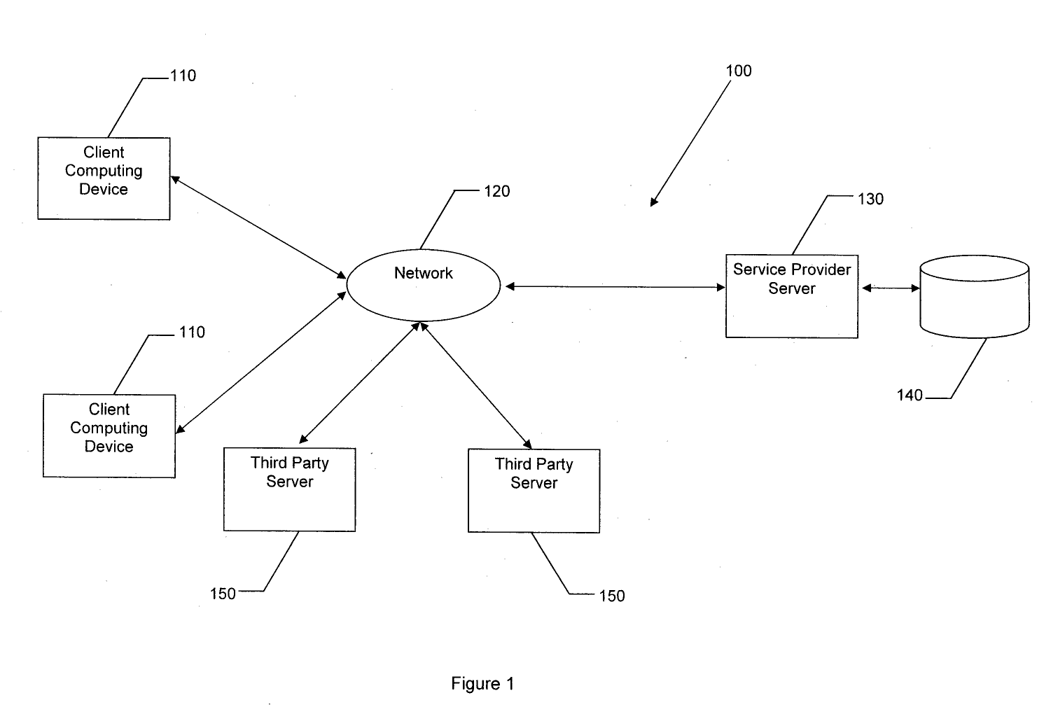

FIG. 1 is a block diagram of an example system 100 within which collaborative portfolio optimisation functionality, according to various example embodiments, may be provided. The system 100 may include client computing devices 110, a network 120, a service provider server 130, a data store 140, and third party servers 150. The client computing devices 110 may be used by an online community of users (or members) to interact with the service provider 140 through the service provider server 130. The service provider server 130 may provide collaborative portfolio services as a software as a service (SaaS), and the online community of users may include subscribers to the SaaS.

The third party servers 150 may provide data or services to the service provider server 130 associated with actual or proposed portfolios of investments created by the users. The data store 140 may store data received at the service provider server 130 from the users and/or the third party servers 150 associated with the user portfolios. The data store 140 may be in communication with the service provider server 130.

The network 120 may be a wide area network (WAN) such as the Internet. The client computing devices 110 may communicate with the service provider server 130 via the network 120. The client computing devices 110 may run one or more web applications, standalone applications or mobile applications for interacting with the service provider server 130. The service provider server 130, and the third party servers 150, may include one or more of the following: an application server, a data store, such as the data store 140, a database server, and a middleware server. The service provider server 130 may exist on one machine or may be running in a distributed configuration on one or more machines, such as a cloud computing or virtual server environment.

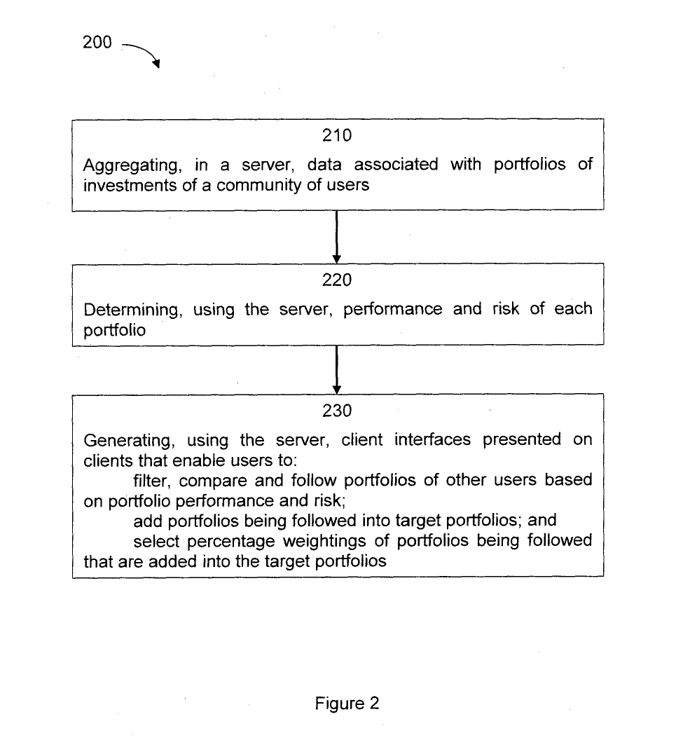

FIG. 2 is a flowchart illustrating an example method implemented by the system of FIG. 1. The steps of FIG. 2 are described as being performed by the service provider server 130. At step 210, the service provider server 130 may receive data associated with portfolios of investments of the online community of users. The online community of users may be members of one or more online sub-communities comprising professional investors, members of online social networks (eg, Twitter, LinkedIn, Facebook, etc), subscribers to online financial services, members of SMSFs, and combinations thereof. The investments may be market tradeable assets or liabilities selected from a group comprising stocks, equity securities, debt securities, term deposits, derivative contracts, bonds, ETFs, cash, and combinations thereof.

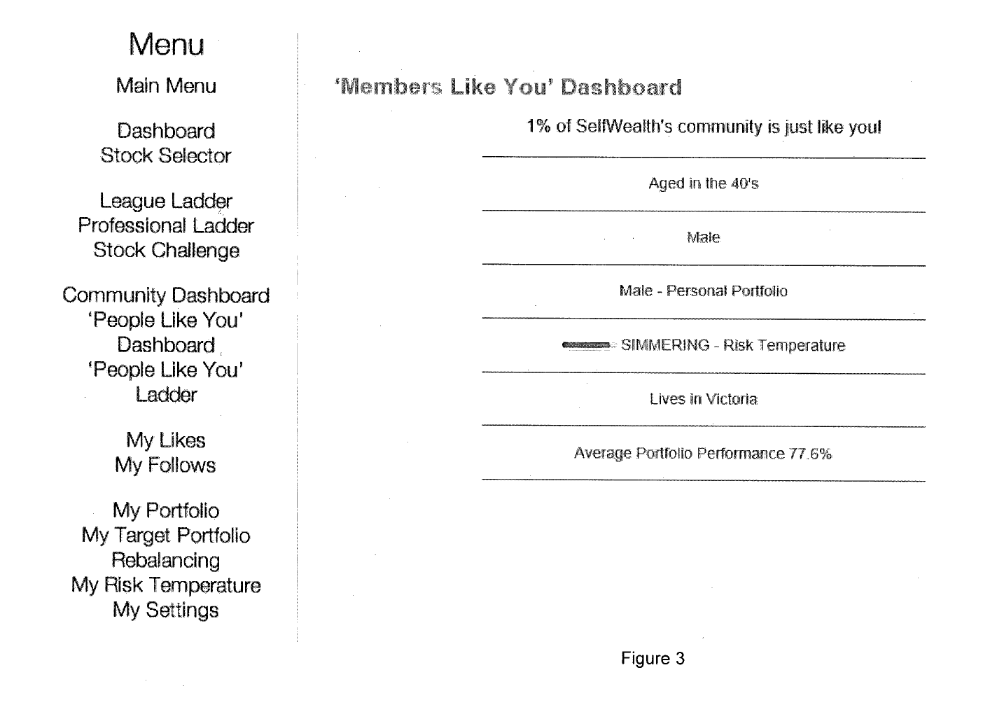

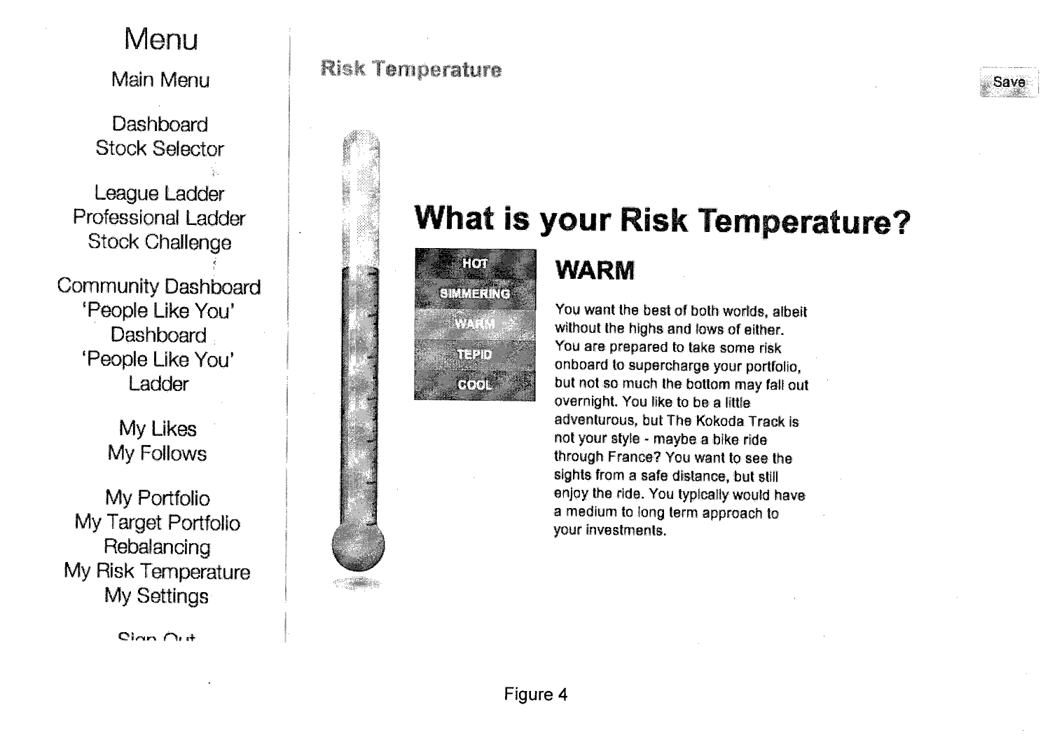

The data received in the service provider server 130 at step 210 may include data submitted to the service provider server 130 by users relating to actual or proposed portfolios of investments, such as constituent investments and percentage weightings of investments within portfolios. The data may further include data received by the service provider server 130 from users about themselves, such as user profiles and personal risk tolerances. FIG. 3 is an example screenshot of a user interface called Members Like You which may be generated based on user profile data received at step 210. The Members Like You user interface presents age, gender, risk tolerance (or risk temperature), and location of a user. FIG. 4 is an example screenshot of a user interface called Risk Temperature which enables users to define their personal risk tolerance on a scale in risk increments, such as from cool to hot.

The data aggregated at the service provider server 130 at step 210 may also include data or services provided by the third party servers 150 (eg, ASX, Yodlee, eWAY, Recognia, etc), such as a stock index, real-time stock prices, dividends and dividend periods, constituents of portfolios or the stock index for a given period, stock research and analysis, technical analysis of investments, valuation of investments, brokerage services, electronic trading services, financial information services, etc. The data received in the service provider server 130 at step 210 may also include constituent investments and percentage weightings of investments within portfolios. The user and portfolio data aggregated by the service provider server 130 at step 210 may be stored in the data store 140. The data aggregation functionality at step 210 may be implemented in software as an aggregation module executed by a processor of the service provider server 130.

At step 220, the service provider server 130 determines performance and risk of each portfolio based at least in part on the data aggregated at step 210. The portfolio performance (or return) and risk may be determined since inception of the portfolio, or over a given period such as 1 month, 3 months, 6 months and 1 year. The historic portfolio performance and risk are determined by a processor of the service provider server 130 using conventional calculations of data received at step 210.

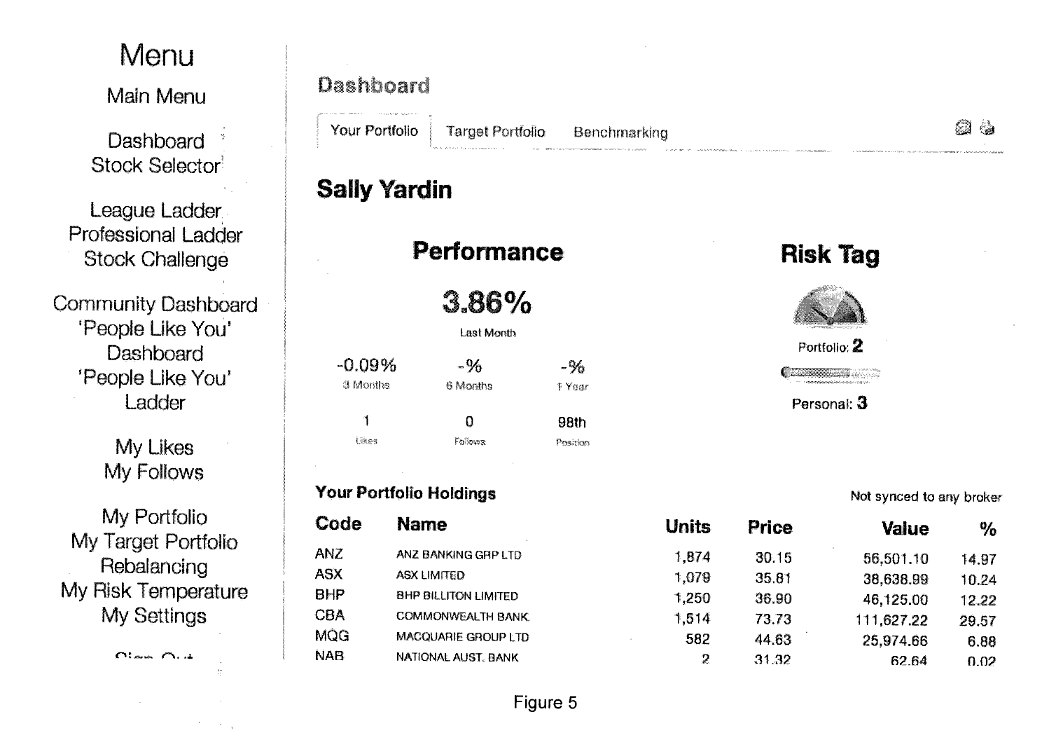

For example, periodic and since inception performance returns of portfolios are calculated daily based on a time-weighted basis using conventional mathematical formulae and performance metrics based on pricing or valuation data received or derived from the third party servers 150 (eg, Financial Simplicity, Recognia, etc), such as stock price, cash, dividends paid, earning distributions, etc. Portfolio risk is, for example, calculated daily using conventional mathematical formulae and risk metrics using data received or derived from the third party servers 150, such as stock holdings, stock spread, percentage of stocks in a market index, changes in stock holdings, stock or asset allocations, etc. FIG. 5 is an example screenshot of a user interface called Dashboard which may be generated to present the performance and risk of a user portfolio determined at step 220. In the Dashboard portfolio risk is graphically represented by a Risk Tag having a scale of risk increments. The portfolio performance and risk analysis functionality at step 220 may be implemented in software as an analysis module executed by a processor of the service provider server 130.

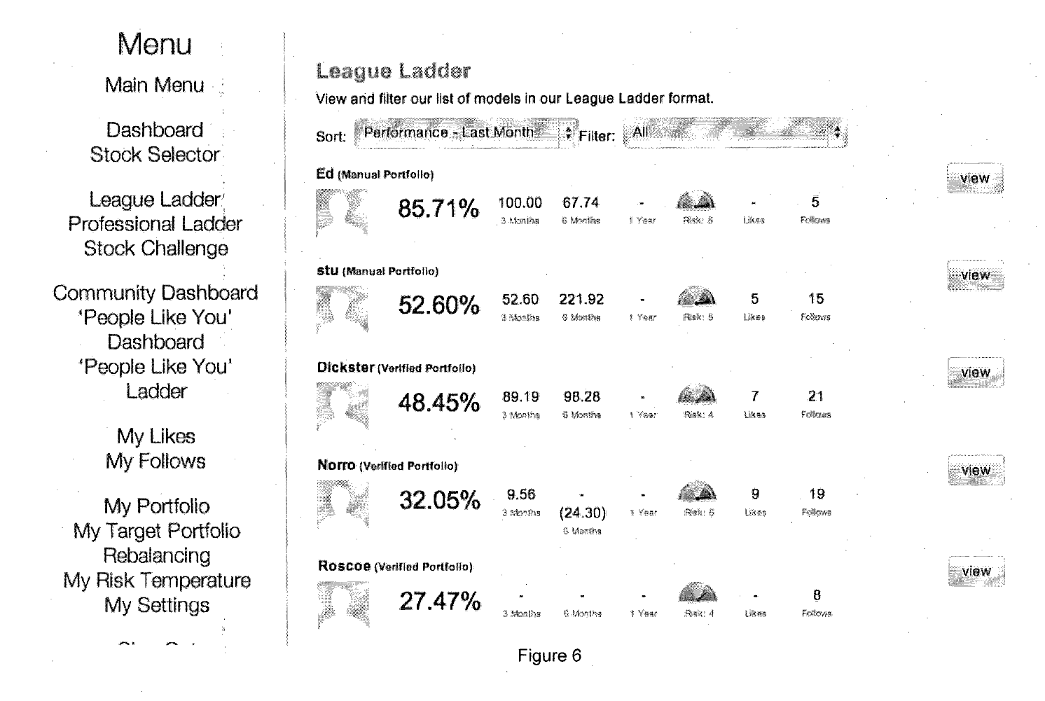

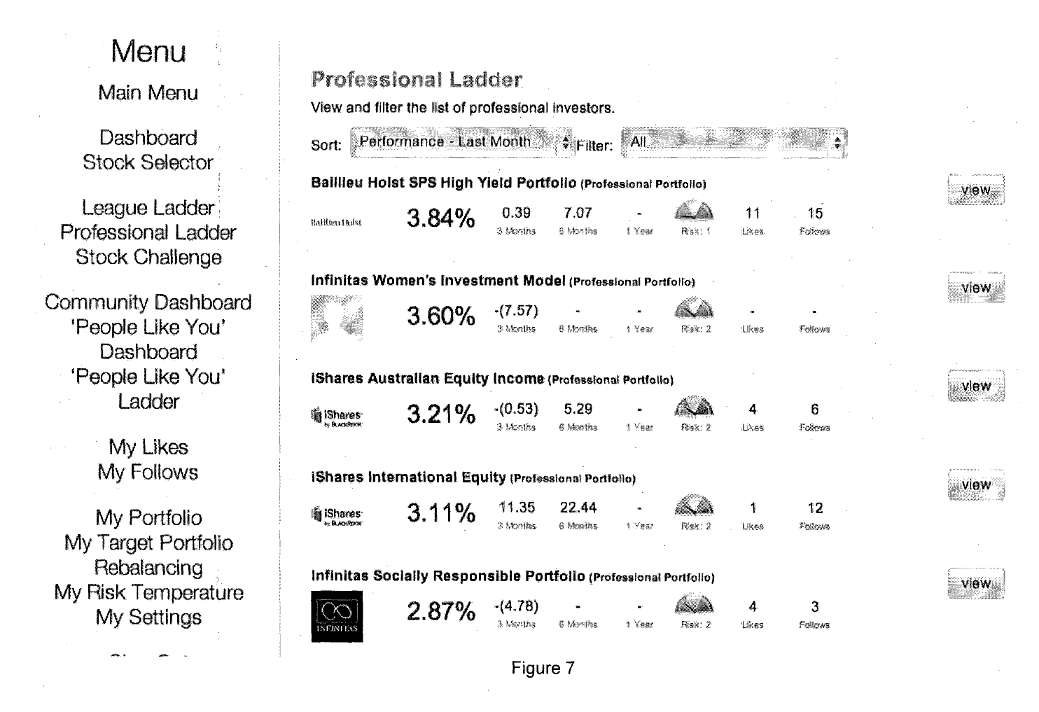

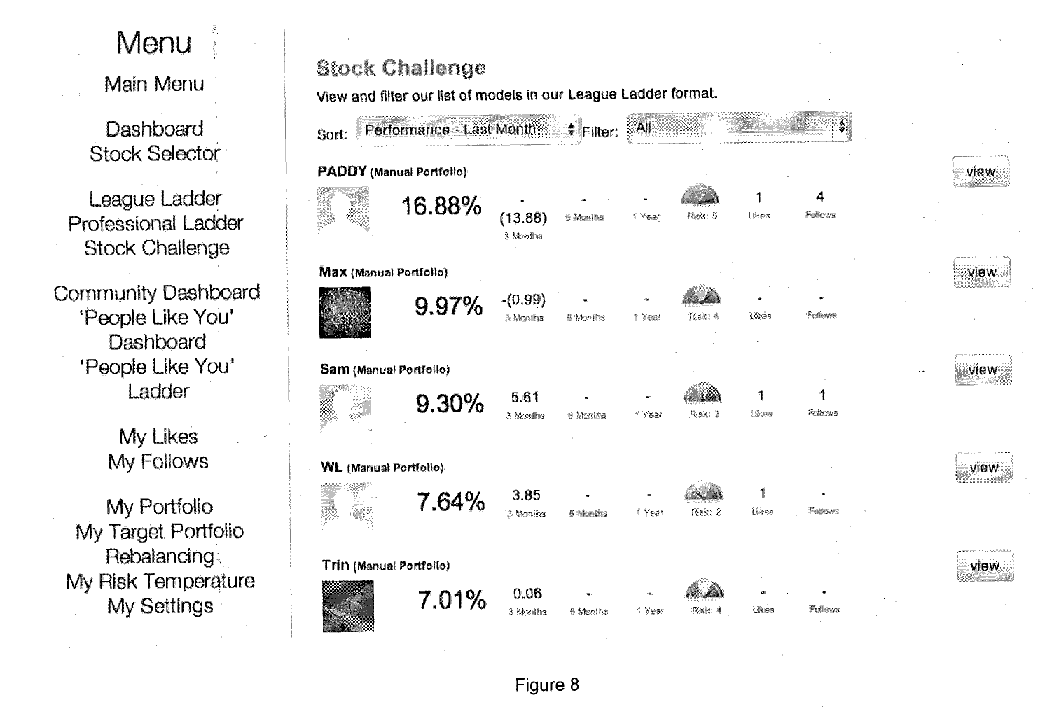

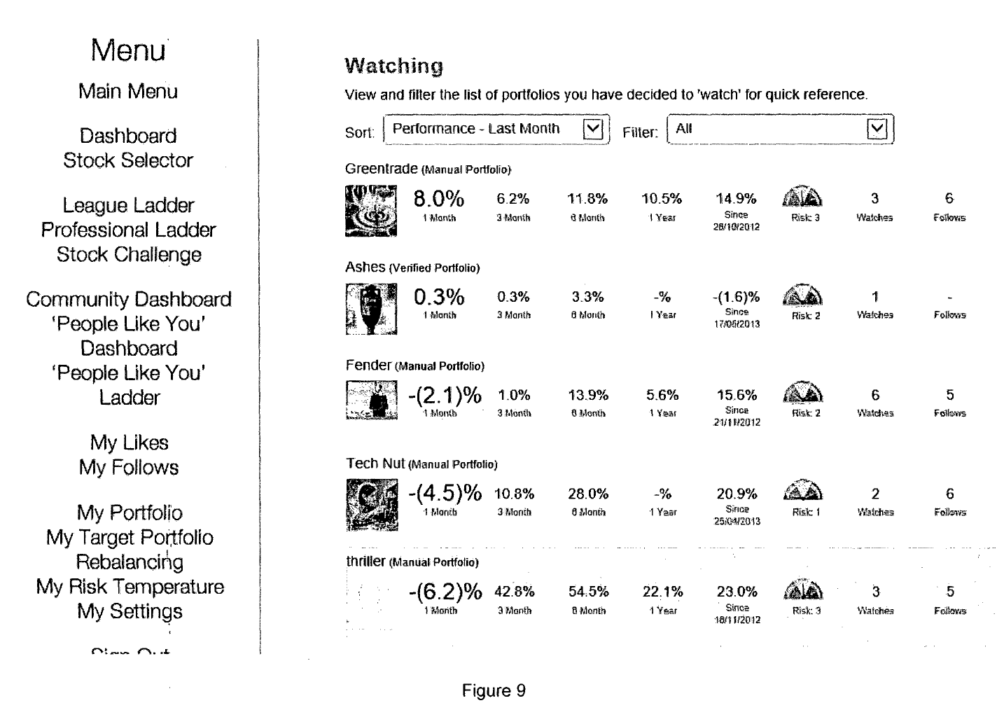

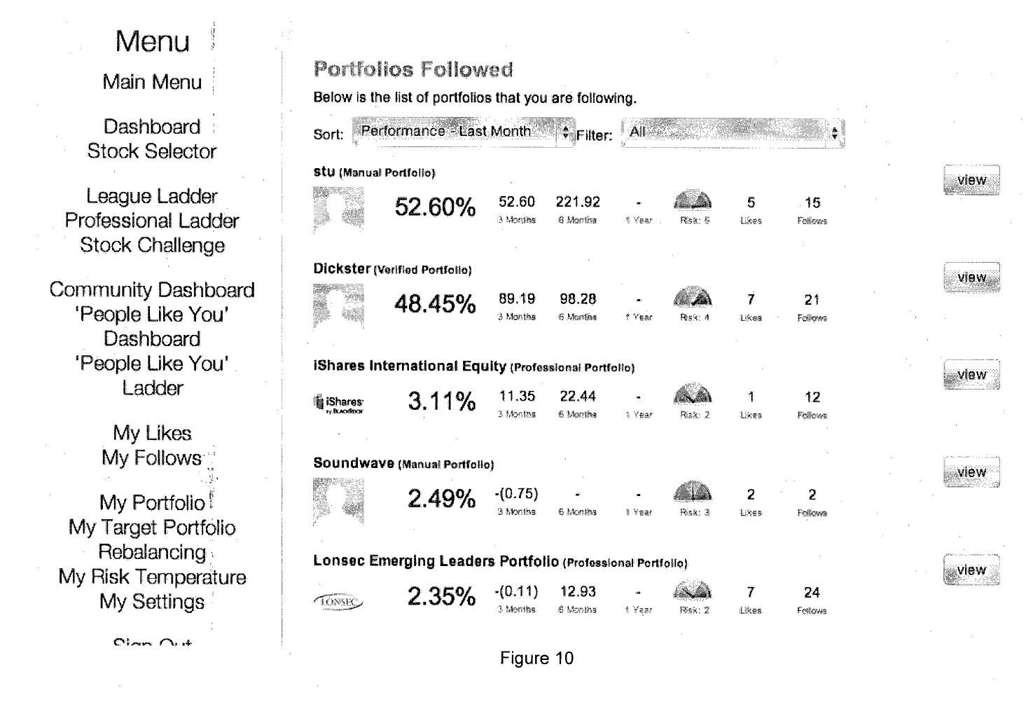

At step 230, the service provider server 130 generates user interfaces presented on client computing devices 110 that enable users to filter, compare and follow portfolios of other users based on the portfolio performance and risk determined at step 220, and user profile data received at step 210. Other equivalent filters, such as financial demographics, social demographics, and group demographics may also be used to filter the aggregated portfolios and users. The user interfaces collectively comprise interactive visual analytical tools to enable members of the online community to collaboratively identify optimal portfolios. The interactive user interface functionality at step 230 may be implemented in software as an interface module executed by a processor of the service provider server 130. FIGS. 6 to 9 are example screenshots of user interfaces respectively called League Ladder, Professional Ladder, Stock Challenge and My Favourites which may be generated to enable users to filter and compare top performing and favourite portfolios of professional and private investor users.

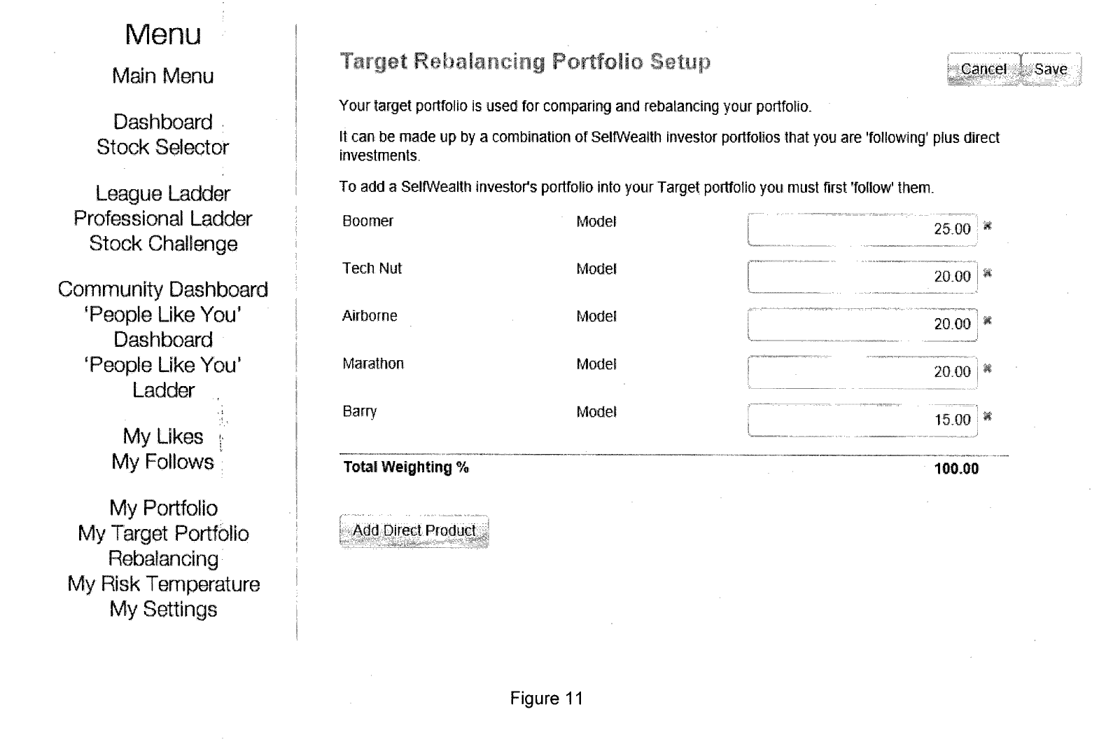

Based on the filtering and comparison, users may select portfolios of other users to follow that match their desired return and risk attributes. FIG. 11 is an example screenshot of a user interface called Portfolios Followed which may be generated at step 230 to summarise portfolios of other users that are being followed by a user. At step 230, users may also add portfolios being followed into target portfolios. The target portfolios may comprise a combination of actual portfolios or direct investments, and a “basket” of one or more portfolios being followed. Users may select and adjust the respective percentage weightings of the portfolios being followed that are added into a target portfolio so that the aggregate risk of the target portfolios is appropriate to their risk tolerance. The analysis module may dynamically determine, and the interface module may dynamically present, aggregate value and risk of the target portfolio as different portfolios being followed are added, and as their respective percentage weighting are adjusted by the user. This computer-implemented functionality automatically merges and transforms actual portfolio data into target portfolio data.

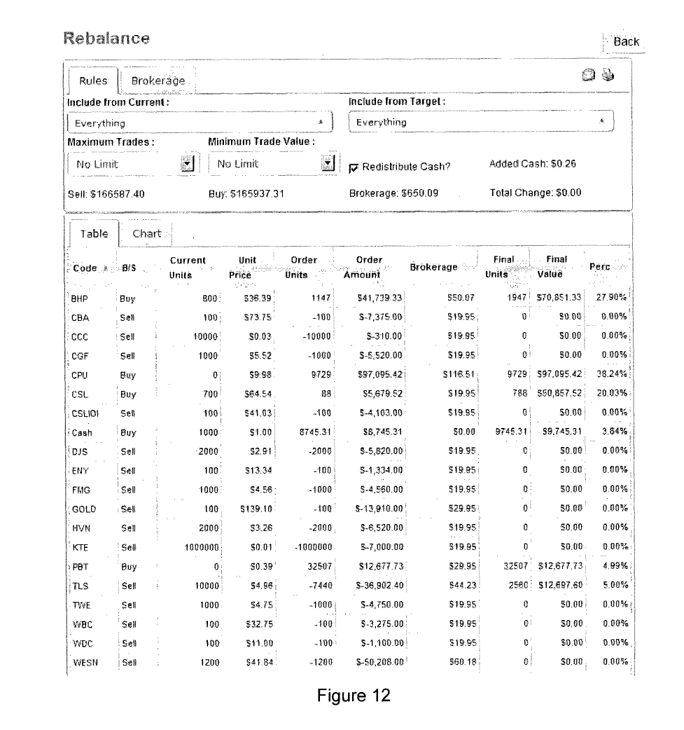

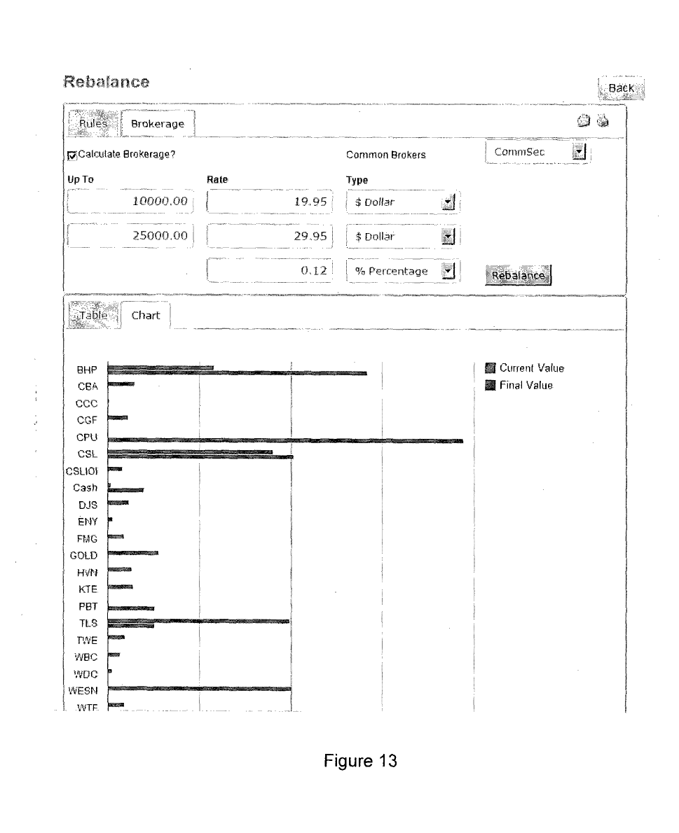

The collaborative portfolio optimisation functionality of the invention further includes determining trades of investments required to rebalance actual portfolios into target portfolios. FIGS. 12 and 13 are example screenshots of user interfaces called Rebalance which may be generated to summarise target portfolio rebalancing in tabular and graphical formats. This rebalancing functionality may be implemented in software as a rebalancing module executed by a processor of the service provider server 130. This computer-implemented functionality enables actual portfolio data to be transformed automatically into target portfolio data.

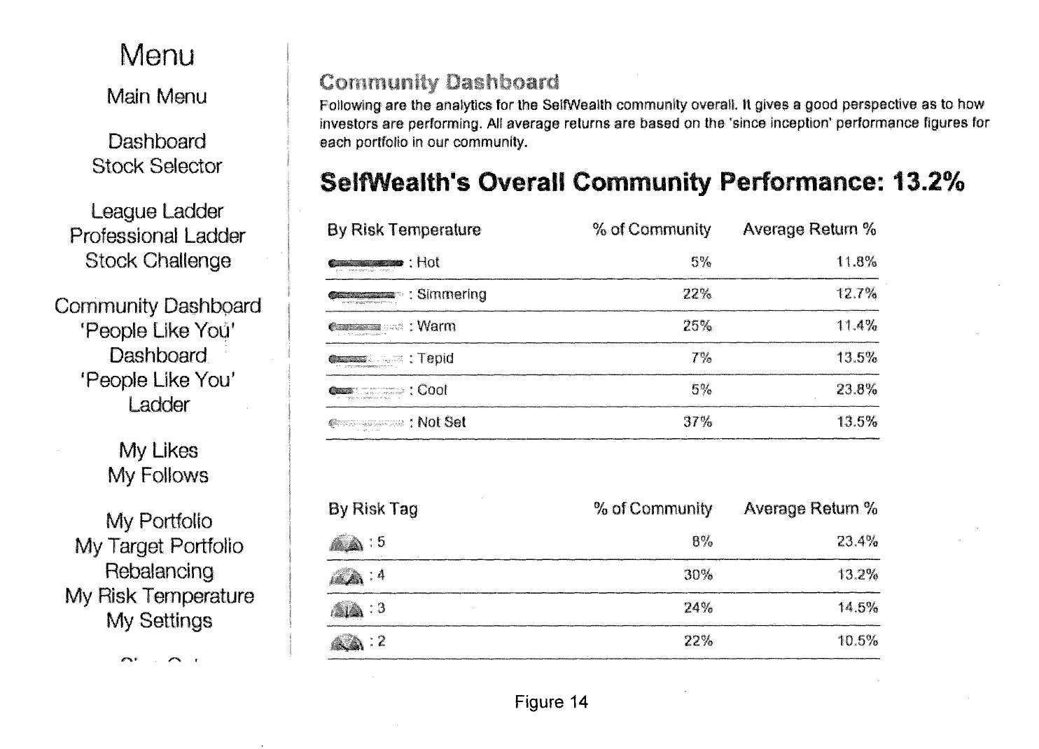

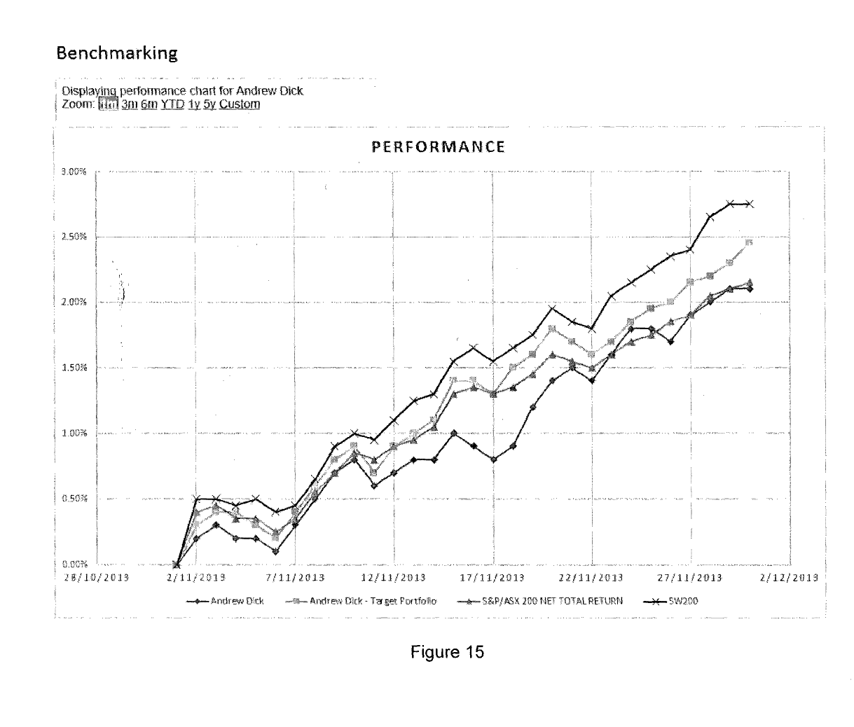

The collaborative portfolio optimisation functionality of the invention also includes determining overall or aggregate collaborative portfolio performance for the online community of users. FIG. 14 is an example screenshot of a user interface called Community Dashboard which summarises the aggregate performance and risk of actual and target portfolios created by the online community of users. The aggregate performance and risk of the collaborative portfolios may be determined at step 220 by the analysis module.

The collaborative portfolio optimisation functionality of the invention further includes generating a collaborative benchmark index of community portfolio performance. This functionality may be implemented in software as an indexing module executed by a processor of the service provider server 130. The collaborative index may be generated by determining top N performing portfolios of investments out of actual and target portfolios of the online community, determining top N performing investments out of the top N performing portfolios of investments, and equal-weighting the top N performing investments to create a collaborative index of investments for the online community. N is, for example, a multiple of 5, such as 100, 200, 300, 400 or 500. The number of investments in the collaborative index may be selected to correspond to a market index to enable performance of the collaborative index to be benchmarked against the market index. For example, where the market index is the S&P/ASX 200, N may be selected to be 200. The indexing module may also be configured to create a collaborative ETF comprising the top N performing investments.

The collaborative index and collaborative ETF may be named based on the online community or sub-communities from which they are derived. For example, the collaborative index may be called the Community 200 Index, and may be electronically published by the service provider server 130. Where the online community of users comprises one or more sub-communities of online users, a collaborative index may also be generated for each online sub-community. For example, when the collaborative index is generated for sub-communities of LinkedIn and Twitter users, the resultant collaborative indices may be called the LinkedIn 200 Index and the Twitter 200 Index.

The collaborative portfolio optimisation functionality of the invention also includes providing user interfaces that enable users to compare or benchmark performance of individual actual or target portfolios with the collaborative index and/or a market index. FIG. 15 is an example screenshot of a user interface called Benchmarking that presents periodic performance of actual and target portfolios against the S&P/ASX 200 index and the collaborative index. This benchmarking functionality may be implemented in software by the interface module executed by a processor of the service provider server 130.

Embodiments of the present invention provide useful solutions that enable individual investors to collaboratively create, compare and select among investment portfolios of online communities of investors to collaboratively optimise the composition and performance of their own portfolios.

The above embodiments have been described by way of example only and modifications are possible within the scope of the claims that follow.

1: A method, comprising:
aggregating, in a server, data associated with portfolios of investments of an online community of users that comprises an online social network of investors;
determining, using the server, performance and risk of each portfolio; and
generating, using the server, user interfaces presented on clients that enable users to:
filter, compare and follow other users based on social network profiles or social demographics of users;
filter, compare and follow portfolios of other users based on portfolio performance and risk;
add portfolios being followed into target portfolios; and
select percentage weightings of portfolios being followed that are added into the target portfolios.

2: The method of claim 1, wherein the user interfaces further enable users to identify trades of investments required to rebalance actual portfolios into target portfolios.

3: The method of claim 2, further comprising:
determining, using the server, top N performing portfolios of investments out of actual and target portfolios of the online community of users;
determining, using the server, top N performing investments out of the top N performing portfolios of investments; and
weighting, using the server, the top N performing investments to create a collaborative index of investments for the online community of users;
wherein N is a multiple of 5.

4: The method of claim 3, further comprising electronically publishing, using the server, the collaborative index.

5: The method of claim 3, further comprising creating, using the server, a collaborative exchange-traded fund (ETF) comprising the top N performing investments.

6: The method of claim 1, wherein the user interfaces further enable users to filter, compare and follow portfolios of other users based on user risk tolerances.

7: The method of claim 3, wherein the user interfaces further enable individual users to collaboratively compare performance of individual actual or target portfolios with the collaborative index and/or a market index.

8: The method of claim 1, wherein the online community of users further comprises one or more online sub-communities selected from professional investors, subscribers to online financial services, members of self managed superannuation funds (SMSFs), and combinations thereof.

9: A system, comprising:
an aggregation module configured to aggregate, in a server, data associated with portfolios of investments of an online community of users that comprises an online social network of investors;
an analysis module configured to determine, using the server, performance and risk of each portfolio; and
an interface module configured to generate, using the server, user interfaces presented on clients that enable users to:
filter, compare and follow other users based on social network profiles or social demographics of users;
filter, compare and follow portfolios of other users based on portfolio performance and risk;
add portfolios being followed into target portfolios; and
select percentage weightings of portfolios being followed that are added into the target portfolios.

10: The system of claim 9, further comprising a rebalancing module configured to generate, using the server, user interfaces presented on clients that enable users to identify trades of investments required to rebalance actual portfolios into target portfolios.

11: The system of claim 10, further comprising an indexing module configured to:
determine, using the server, top N performing portfolios of investments out of actual and target portfolios of the online community of users;
determine, using the server, top N performing investments out of the top N performing portfolios of investments; and
weight, using the server, the top N performing investments to create a collaborative index of investments for the online community of users;
wherein N is a multiple of 5.

12: The system of claim 11, wherein the indexing module is further configured to electronically publish, using the server, the collaborative index.

13: The system of claim 11, wherein the indexing module is further configured to create, using the server, a collaborative ETF comprising the top N performing investments.

14: The system of claim 9, wherein the user interfaces further enable users to filter, compare and follow portfolios of other users based on user risk tolerances.

15: The system of claim 11, wherein the user interfaces further enable individual users to collaboratively compare performance of individual actual or target portfolios with the collaborative index and/or a market index.

16: The system claim 9, wherein the online community of users further comprises one or more online sub-communities selected from professional investors, subscribers to online financial services, members of SMSFs, and combinations thereof.
